(19) United States
(12) Patent Application Publication
(10) Pub. No.: US 2015/0213385 A1
(43) Pub. Date: Jul. 30, 2015

(54) METHOD, SYSTEM AND TOOL FOR FACILITATING INDUSTRIALISED ADHOCRACY

(71) Applicant: David Moloney, Roseville (AU)

(72) Inventor: David Moloney, Roseville (AU)

(21) Appl. No.: 14/345,956

(22) PCT Filed: Sep. 13, 2013
(86) PCT No.: PCT/AU2013/001037

§ 371 Date: Mar. 20, 2014

(30) Foreign Application Priority Data
Sep. 19, 2012 (AU) 2012904084
Dec. 24, 2012 (NZ) 605297
Mar. 15, 2013 (AU) PCT/AU2013/000267
Apr. 9, 2013 (AU) 2013203034

(51) Int. Cl. G06Q 10/06

(52) U.S. Cl. CPC G06Q 10/06315

(57) ABSTRACT

A computer-enabled method, system and tool for facilitating industrialised adhocracy that provides efficient matching of organisational need to a work component (or other resource component) required. The preferred embodiments facilitate the defining of an organisational need as one or more work components (or other resource component), each work component being a discrete unit of work in indivisible form. This provides granularity in defining a resource required to meet an identified organisational need and thereby facilitates matching resources to need. The preferred embodiments also deliver matched resources (e.g. professional expertise) to the componentisation of need identified.

### TECHNICAL FIELD

The present invention relates to systems and methods for improving organisational performance through the blending of internal and external resources.

### BACKGROUND

The importance of organisational structure for effectiveness and efficiency is well recognised.

Management consultancies are often engaged by organisations to improve operational efficiency, assist in change management, and develop and implement strategies for growth. Typically external management consultants are used, because many organisations do not have the required in-house resources (available personnel with the relevant skills and expertise) to identify organisational problems or needs. Sourcing the appropriate expertise and skills to address the identified organisational needs can pose difficulties for organisations, in relation to increased infrastructure costs, particularly if the needs are short term or only required on an ad hoc basis.

With the rise of the “super temp” in the past decade (experienced personnel with saleable expertise seeking employment for short engagement terms only), there is increasing availability of the talent base to enable the creation and building of adhocracies. Organisations are therefore increasingly seeing these super temps are viable alternatives to both full time employees and traditional consulting firms. Over-time this trend is increasing the number of in-house activities performed as consultants rather than as employees. This allows access to expertise as the need arises, without permanently increasing operational costs.

However, sourcing specialist expertise in a timely and effective manner can be problematic because it relies on:
(a) previous experience or word of mouth recommendations, which can be both limited in range and time-consuming, because referral networks are informal and the relevant specialist expert may not be accessible nor available; or
(b) standard resourcing (recruitment) business models, including advertising a permanent or temporary position then waiting for applications (or “bids”) from applicants. The outcome of this approach can be unreliable (e.g. in terms of relevance of an applicant's skills or the appropriateness of the expertise) and is often both time consuming and expensive (both use of internal resources and fees for the service).

Growth in outsourcing over the last two decades has been supported by the development of internal RFP (Request For Proposal) capabilities as part of an organisation's strategic sourcing capabilities. These capabilities are built for large scale sourcing and outsourcing agreement (large scale IT programs, off shoring and Telecoms) and to manage general agreements with suppliers of goods and services from paper clips to new CEOs. However, they are not configured to manage the creation of adhocracies, whether to supply a single individual to augment capabilities on a critical project, or quickly build a uniquely configured team to support a major transformation effort. These tasks have instead been left (until now) to a range of lesser substitute models, each of which have disadvantages relative to industrialised adhocracy.

Organisational performance can be improved if organisations can act in an agile manner to respond to ad hoc needs. There is a growing literature that talks about the need (and desire) for organisational structures that enable “ambidexterity” (usually defined as the capacity to both “exploit” existing capabilities and “explore” new bases for competitive advantage). Examples include the need to resolve a problem, to capture an opportunity or to implement a growth strategy. However, a difficulty faced by many organisations is that they lack agility—whether because of inadequate resources to redirect to a new need or because they are constrained by the organisational structure.

An adhocracy is a dynamic organisational structure that allows an organisation to adapt to respond to an immediate need (e.g. a threat or opportunity). It sits at the opposite end of the spectrum of organisational structures to a bureaucracy. A bureaucracy (according to Max Weber's definition of an ideal bureaucracy) achieves its own form of efficiency through hierarchical organization, delineated lines of authority in a fixed area of activity, and action taken on the basis of and recorded in written rules. These characteristics are believed to facilitate the efficient performance of tasks, because they drive rational, systematic and impersonal (objective) decision-making, as opposed to personal decisions that are subject to whim. Bureaucracy is typically characterised as efficient where an organisation faces a limited number of “knowable” situations. In such a situation knowing that applying “Rule X provides the best outcome for ‘Situation Y’” is very helpful. However, as the situations faced by organisations are increasingly of a novel nature, a rule-following approach becomes a constraint on efficiency.

By contrast, an adhocracy relies on horizontal job specialisation, in which teams (often including specialists) are deployed to capture an opportunity or solve a problem. A critical component of adhocracy is the capacity to form and disband teams to meet the requirements of specific projects. As such, work organisation rests on teams constructed specifically for the task at hand and can exploit available internal resources and be augmented with super temps to create the ideal adhocracy. Alternatively the complete adhocracy can be constructed from external sources. Additional productivity gains come from dividing work into ever smaller tasks performed by ever more specialised workers (see: Malone T W, Laubacher R J, Johns T. ‘The Big Idea: The Age of Hyperspecialization’, Harvard Business Review, July 2011).

Adhocracies are increasingly used in a number of industries, and are considered a cost-effective and efficient way to bring together the required expertise to achieve a desired outcome. Each adhocracy is unique; it blends specialist and general skills of different durations to align to the specific needs of often complex projects.

Examples include the construction, information technology (IT), and film industries, where highly specialised skills are required for a period of time to deliver a finished product.

The potential for adhocracies to be used as an organisational structure for improving operational performance in other areas of business (including for change management or meeting ad hoc needs) is potentially even greater than for producing physical products (because there are no operational issues requiring physical matching of services). However, to date, there is no industrialised method for building adhocracies, apart from relying on word-of-mouth, or traditional talent resourcing models, which suffer a number of disadvantages.

There is an opportunity for organisations to improve organisational performance (including to meet short-term or ad hoc needs) by building an adhocracy on an as needs basis. However, there is currently no readily available, efficient method to achieve this. It would be useful to have a system and method for industrialising adhocracy that empowers organisations to build an adhocracy.

Various computer implemented methods exist to facilitate the procurement of services, including project-based services. For example, US 2001/0032170 provides a private market place for procuring services and US 2003/0216928 describes a marketplace for knowledge-based services in which various entities interact according to a hierarchy of business rules. However, these systems are directed at managing the process of matching service requests (job descriptions or requests for proposal) against “vendors” who apply (bid) to provide the requested service.

Both systems of US 2001/0032170 and US 2003/0216928 share the common disadvantage of the organisation requiring the service(s) needing to review service providers who put themselves forward as appropriate to fulfil a particular service request. In this way, neither system would address the efficiency or reliability problems of traditional resourcing business models. For example, US 2001/0032170 requires the person who needs services to invite specific vendors to bid, and then to review all of the bids submitted. This is resource intensive and time consuming.

The system of US 2003/0216928 relies on service providers complying with:
(a) market rules for interacting with the marketplace;
(b) enterprise rules for interacting with a specific enterprise within the marketplace; then
(c) a profiling module, which is intended to facilitate creation of a representation of a service provider's knowledge for assessment by an enterprise (by incorporating predefined terminology to facilitate matching of service requests to service providers). The system matches self-declared skills using predefined terminology but does not otherwise vet service providers. This vetting process still falls on the organisation in need of services.

This approach suffers the disadvantage that service providers who do not have the appropriate expertise (yet self-declare to have the required skills) can still comply with the relevant rules, complete a profiling module and affiliate with an enterprise within the marketplace for consideration. This does not necessarily ensure that time is spent only on assessing suitable service providers.

Further neither US 2001/0032170 nor US 2003/0216928 takes a whole-of-organisation approach to building an adhocracy. Without adopting a holistic approach, there may be no oversight to match a service request (or request for proposal) to the organisational structure as a whole. As a result, both US 2001/0032170 and US 2003/0216928 suffer the disadvantage that they do not address the need for operational efficiency between an adhocracy and how it operates with (and within) an existing organisational structure. This blend is an issue for management consulting firms who arrive at an organisation with their own organisational pyramid which struggles to enmesh. Adhocracies can be made up of one person who is changed in or out of a team (e.g. substituting one team member) but are typically made up of small teams of 2 to 3, to very large teams of several hundred—for example, to build a submarine or sky scraper.

WO 02/093448 discloses a method of assessing the culture of an organisation and making improvements thereon, based on the assessment. However, the method described in WO 02/093448 focuses on assessing culture of an organisation through surveys, interviews, staff meetings and other forums to seek employee opinions. The method of WO 02/093448 does not describe steps that an organisation can perform to change organisational, operational structure through building of one or more adhocracies to address an identified organisational need. A further disadvantage of the method of WO 02/093448 is that it does not assist an organisation in the process of blending internal and external resources (contractors, consultants or other service providers) to meet an organisational need.

Various professional networks and groups exist, often as a means for individual service providers to promote their consulting capabilities and for companies to access such consulting skills and expertise. Such networks and groups have varying degrees of eligibility (ranging from an individual service provider/expert simply “opting in” to a specific group, to inclusion in a group after referral from an existing group member). However, such professional groups do not vet the members applying for consulting projects or assess the suitability of a member's skills to deliver specific services. Some of these professional groups exist purely as a discussion group, intended to generate connections rather than being a method of sourcing resources (service providers, consultants, contractors).

Some professional networks provide a platform for the market to request services from self-proclaimed experts or peer-recognised experts and for members of these professional networks to respond to such requests. However, a payment request through the network may be the only record that a consultation has taken place. The network has no other engagement or involvement in the final selection of a consultant. Therefore, such groups share some of the disadvantages of the systems discussed above. Further, these networks are essentially a passive medium that facilitate connections rather than actively facilitating and engaging in the effective sourcing of high quality, experienced and reliable expertise.

There is a need for a new or alternative (and improved) method of industrialised adhocracy that empowers an organisation to build its own adhocracies by acquiring resources in an efficient, flexible and reliable manner that at least partly overcomes the difficulties of traditional resourcing business models in blending internal and external resources.

It is an object of the present invention to provide a method for industrialising adhocracy that at least partly addresses the difficulty of current resourcing models by empowering an organisation to build its own adhocracies.

### SUMMARY

According to an aspect of the invention there is provided a componentisation tool for performing a method of industrialising adhocracy,

wherein the method includes a componentisation process,
wherein the componentisation process is performed by programming instructions embodied in a computer readable storage medium and includes the steps of:
(a) capturing organisational data, wherein the organisational data includes data regarding one or more of the following:
   i. an organisation's existing operations;
   ii. an organisation's existing resources;
   iii. an organisation's need;
(b) processing said organisational data to assess whether one or more of the following are sufficient to meet an organisation's need:
   i. an organisation's existing operations;
   ii. an organisation's existing resources;
(c) calculating a difference between:
   i. existing operations and existing resources; and
   ii. an organisational need,
to identify one or more work components required to address the organisational need;
(d) defining a resource required to meet each said identified one or more work components required by an organisation,
(e) selecting one or more resources from a pool of relevant expertise using a fitness function to meet the resource so defined,
   wherein each said one or more work components is a discrete unit of work in indivisible form such that granularity is provided in defining a resource required to provide each said identified one or more work components required by an organisation or a part thereof.

According to another aspect of the invention there is provided a computer-enabled method of industrialising adhocracy including a componentisation process, wherein the componentisation process is performed by programming instructions embodied in a computer readable storage medium, wherein the componentisation process includes the steps of:
a. capturing organisational data, wherein the organisational data includes data regarding one or more of the following:
   i. an organisation's existing operations;
   ii. an organisation's existing resources;
   iii. an organisation's need;
b. processing said organisational data to assess whether one or more of the following are sufficient to meet an organisation's need:
   i. an organisation's existing operations;
   ii. an organisation's existing resources;
c. calculating a difference between:
   i. existing operations and existing resources; and
   ii. an organisational need,
to identify one or more work components required to address the organisational need;
d. defining a resource required to meet each said identified one or more work components required by an organisation,
e. selecting one or more resources from a pool of relevant expertise using a fitness function to meet the resource so defined,
   wherein each said one or more work components is a discrete unit of work in indivisible form such that granularity is provided in defining a resource required to provide each said identified one or more work components required by an organisation or a part thereof.

According to yet another aspect of the invention there is provided a system for industrialising adhocracy, including:
(a) a componentisation tool as herein described; and
(b) a method of industrialising adhocracy as herein described.

### DETAILED DESCRIPTION

The invention thus provides a new or alternative method, system and tool for industrialising adhocracy that empowers an organisation to build its own adhocracies by providing an effective and flexible means to acquire resources that at least partly overcomes the difficulties of traditional resourcing business models in blending internal and external resources. This is at least partly achieved by capturing organisational data, assessing resources available as being sufficient to meet an organisation's need, then calculating a difference between existing operations and existing resources to isolate one or more work components required to address the organisational need, so as to define a resource required to meet each said identified one or more work components required by an organisation.

In one embodiment, the sourcing of relevant resources to address identified organisational need is achieved through a multi-filter process performed in iterative fashion as a selection means for each acquired resource, wherein the multi-filter process incorporates the application of a genetic algorithm to clear market demand and supply by efficiently matching an organisational need with relevant expertise. The incorporation of a genetic algorithm generates possible solutions to meet organisational needs as they develop or evolve.

For a better understanding of the invention and to show how it may be performed, a preferred embodiment will now be described, by way of non-limiting example only, with reference to the accompanying drawings.

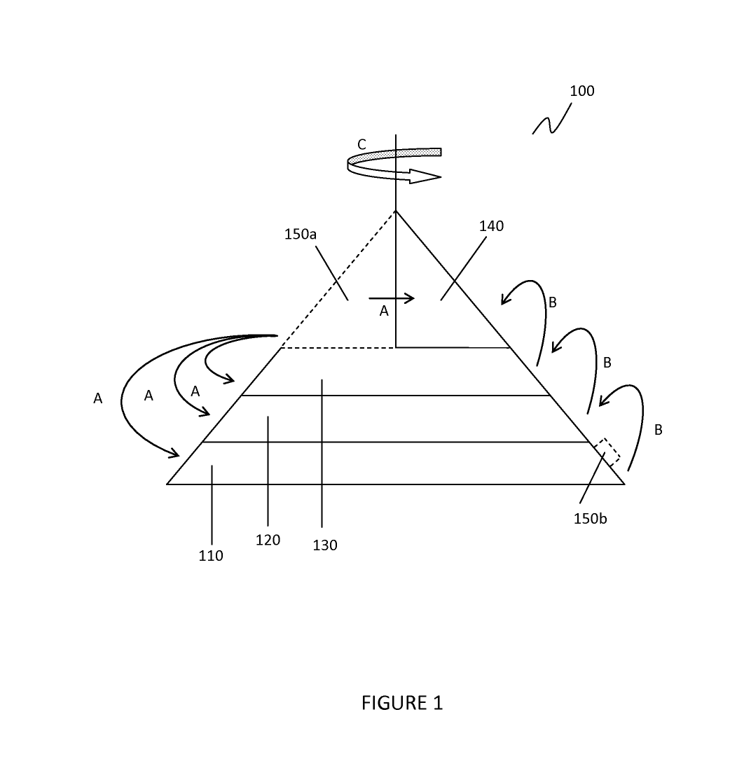

FIG. 1 is a schematic illustration showing an example of an organisational structure that incorporates an adhocracy.

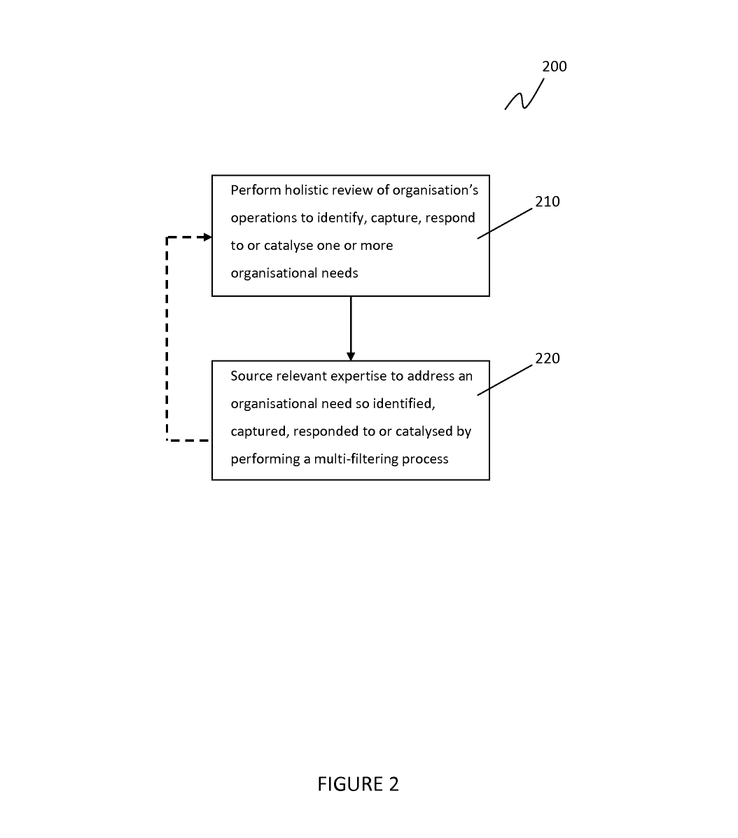

FIG. 2 is a flowchart showing the method of industrialising adhocracy according to an embodiment.

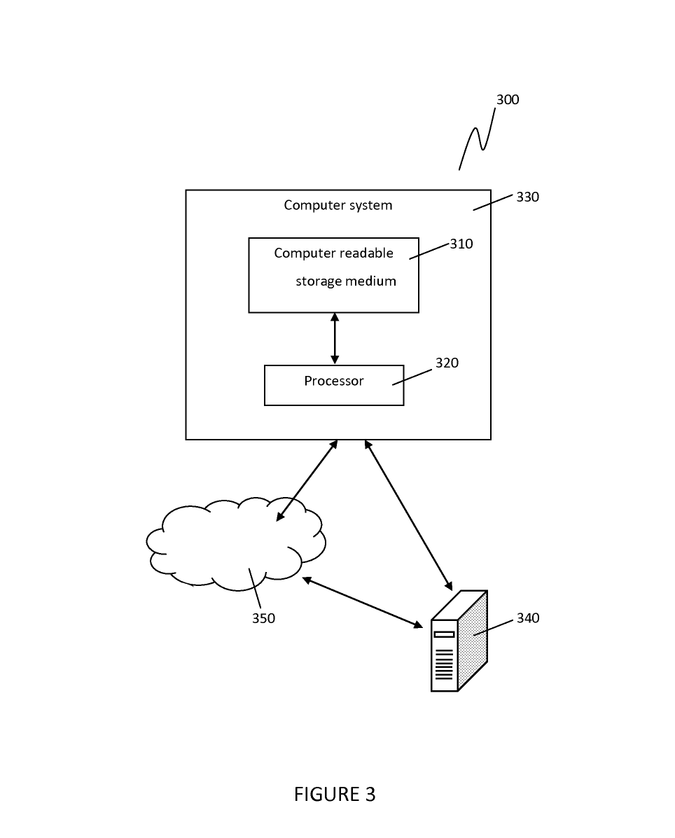

FIG. 3 is a schematic block diagram showing a componentisation tool according to an embodiment of the invention, the tool being a computer program product embodied in a computer readable storage medium for facilitating identification of one or more work components required.

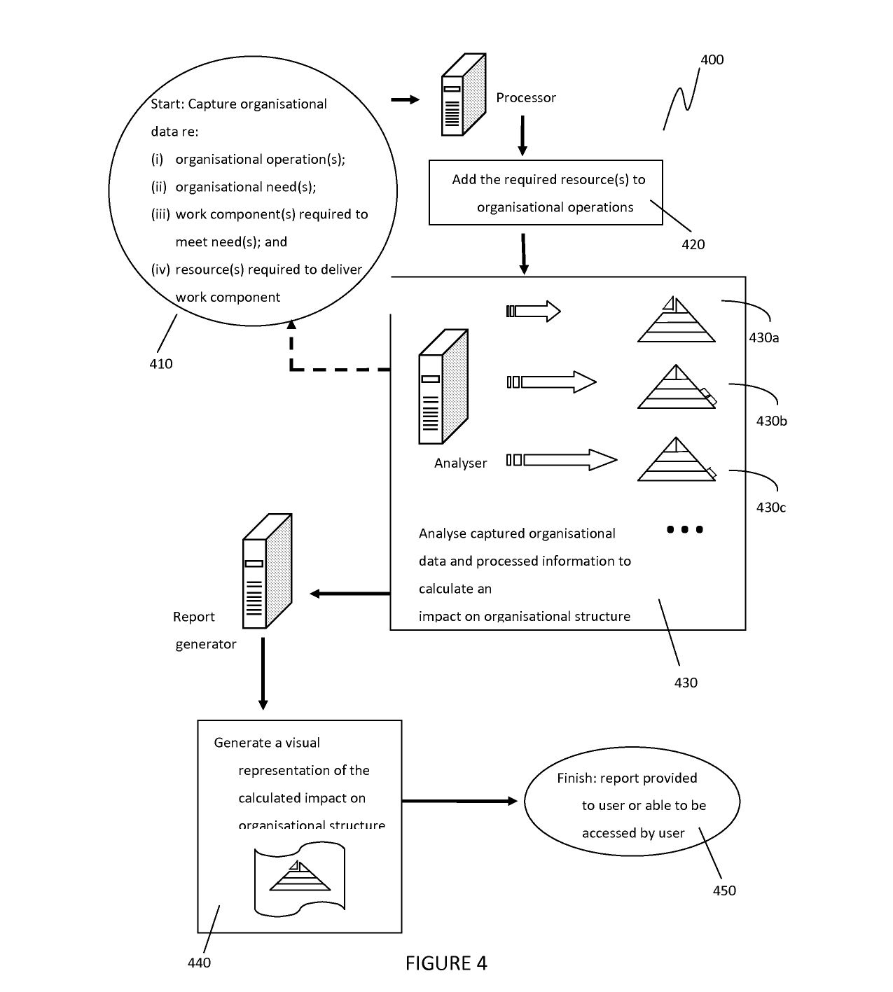

FIG. 4 is a flowchart showing the method of componentising work as performed by an embodiment of the componentisation tool.

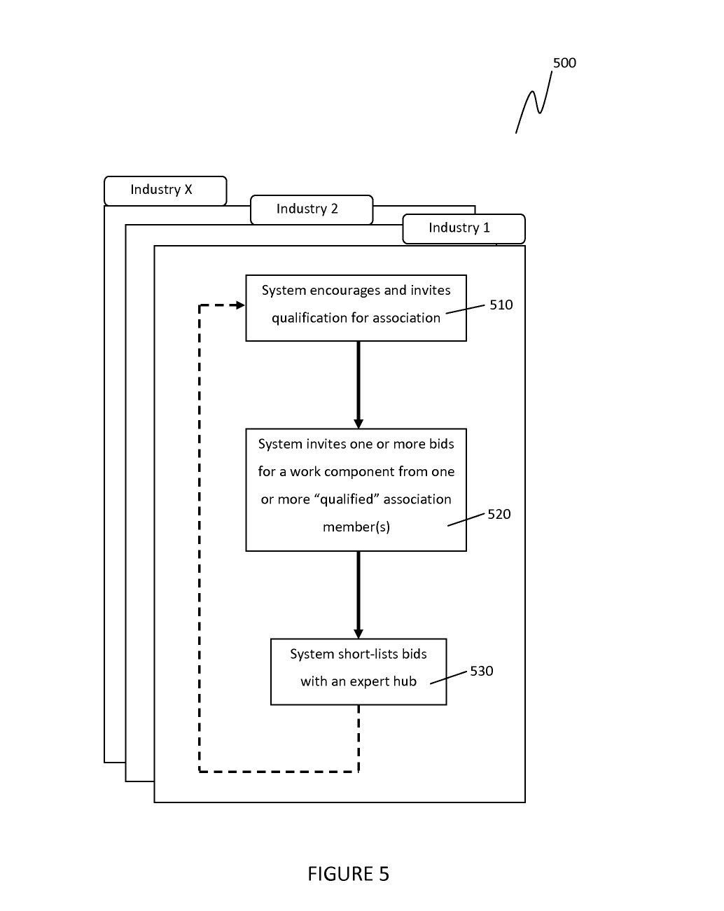

FIG. 5 is a flowchart showing the multi-filter process for matching a resource requirement to a service provider according to an embodiment of a system for industrialising adhocracy.

The elements of the invention are now described under the following headings:

### DETAILED DESCRIPTION OF A PREFERRED EMBODIMENT

The invention thus provides a new or alternative method, system and tool for industrialising adhocracy that empowers an organisation to build its own adhocracies by sourcing and acquiring resources in a manner that at least partly overcomes the difficulties of traditional resourcing business models in blending internal and external resources. This is achieved by:
(a) the breaking down of organisational need into resource components, where each resource component required by an organisation (or a part thereof) is described as a discrete component or unit of a required resource in indivisible form;
(b) the sourcing of relevant resources to address identified organisational needs (each resource matched to the work or other resource component identified) through a multi-filter process performed in iterative fashion for each acquired resource, and wherein the multi-filter process clears market demand and supply by efficiently matching an organisational need with relevant expertise; and
(c) the multi-filter process incorporates the application of a genetic algorithm to select and isolate possible and suitable candidates for resource allocation. This genetic algorithm uses a resource allocator to select one or more candidates from a talent pool (e.g. candidates selected from a pool of experts, members of a professional organisation, “qualified” members of a member association) to select the most suitable expertise for a specified purpose using a fitness function. This fitness function is part of a genetic algorithm to select a “best fit for purpose” approach to put forward the best “affiliate” or expert for the specific environmental problems described (a “best affiliate forward” approach).

FIG. 1 is a schematic illustration of an exemplary organisational structure 100 that incorporates an adhocracy. The shape of the structure 100 and each of the layers or sectors making up the structure 100 are by way of example only. The large triangle represents the overall organisational structure 100. At the base of the organisation is an operational layer 110 that represents the “front line” 110 or customer interfacing resources and operations of the organisation. The next layer 120 is a “middle office” 120 layer of resources and operations that supports the front line. The middle office 120 is supported by back office 130 operations. At the top sit the “headquarter” sectors 140, 150a of the organisation. Sector 140 is concerned with “running” the organisation. Sector 150a represents a possible area for adhocracy (depicted schematically as the shape outlined with a dashed line) and is concerned with improving or changing or adding to or reducing or merging the organisation.

Adhocracy sector 150a represents a possible area for one or more adhocracies to be built, as such adhocracy sector 150a works with (and within) the existing organisational structure. Adhocracy sector 150a is represented schematically as operating or fitting within the organisational structure 100 adjacent to “headquarters” sector 140. Equally, however, there could be sitting an adhocracy sector 150b (only one example is illustrated in FIG. 1):
(a) adjacent to the “middle office” layer 120, the “back office” layer 130, or “front line” sector 110 (see the item labelled 150b in FIG. 1);
(b) adjacent to any combination of the above sectors 110 to 140; or
(c) across all sectors 110, 120, 130 and 140.

The above description illustrates the manner in which the method for industrialising adhocracy selects appropriate resources for an organisational need. The resources are custom filtered using a genetic algorithm to meet the needs of an individual organisation or part thereof. This is achieved through “componentisation” of the resource(s) required into discrete units (components) of work (or other resources) in indivisible form. Breaking down required resources into indivisible units or components (e.g. work components) provides granularity, which improves the matching of resources to the meet. Blending of internal and external resources is facilitated through componentisation of work (or other resource) components (each work component being indivisible) and through the iterative manner in which the adhocracy is built, selecting and adding individual resources (e.g. experts) to the organisation through a multi-filtering process incorporating the application of a genetic algorithm and reviewing organisational performance and satisfaction with each added resource (service provider) with each cycle.

Organisational gaps are specified in terms of one or more resource needs, in their indivisible forms and so are represented as one or more units. This enables the skills of a candidate, expressed as an encoded fitness measure extracted from the fitness function of the genetic algorithm, to be evaluated against an organisation's unitary requirements. Therefore, potential candidates are enabled to be represented as an array of encodings to be fitted into the one or more organisational units, depending on their “fitness”.

These candidate encoded fitness measures are a means of assessing each and every candidate for fitting to an organisational need. The organisational need, in its granular form, enables a candidate's skill set to be “fitted” to the organisation need, since both are expressed in an encoded attributes similar to a lock and key model, where the closeness to fit is expressed in mathematical nomenclature.

For example, a candidate's skills are represented as encoded attributes, expressed as a numerical sequence, bit pattern, alphanumeric representation or other form of encoding. In some embodiments, the candidate's encoded attributes may take the form of, for example, a numerical sequence which may weight some attributes over others, extract attributes not required and/or provide an output to normalise candidates or to rank candidates as most to least suitable for a specified need such that a candidate “fitness” measure is enabled to be extracted.

Candidate “fitness” in further embodiments is enabled to be expressed to reflect some or all required attributes for candidate selection and modelling (similar to gene expression) when placed into a particular organisational environment. This allows organisational need to be met, in its indivisible form(s), by the selection of specific candidates with those skills or attributes to meet those organisational needs.

The application of a genetic algorithm to this encoded candidate attributes and organisational need enables the probability of an outcome to be optimised and manifest in a particular manner. Such attributes may include previous experience to support skill declarations, education, training and other information that may be considered as relevant attribute of the candidate.

In further embodiments a candidate's attributes are enabled to be harvested and/or extracted from pre-existing databases and information sources (with the appropriate cross-checking of data sources for information inconsistencies) and encoded according to a predetermined organisational need or a hybrid of hypothetical organisational needs.

In the preferred embodiment, organisational need is determined prior to assessment for which candidates will provide the most suitable attributes to fulfill such organisational need. This organisational need is often expressed in terms of a project plan where the indivisible resource requirement is expressed in the form of a candidate with particular attributes, so one or more candidates are able to be placed at a specific location to perform a specified task.

Such a project plan in one embodiment is a representation of the solution domain for a genetic algorithm to make the determination(s) as to which candidates are the most suitable for the organisational need. The indivisibility of each organisational requirement in further embodiments takes the form of encoded requirements. This enables one or more candidates, who have been selected as being the “fittest” by the fitness function by filtering their attributes as encoded (usually in a templated manner), are enabled to be matched with organisational encoded requirements, so as to be placed to meet specific needs. This filtering using a genetic algorithm's fitness function to select and allocate one or more of the fittest candidates is termed the “best affiliate forward”.

Such determination of the most suitable candidate in further embodiments is enabled to be reviewed so that if a selected candidate does not, for example, see a fit between their skill set and the position to meet the organisational need, then the candidate is able to add to their attributes to carve out skills where they may over-reach. This enables a negative skill to be encoded as an attribute so as to more specifically align attributes with organisational need. The feed-forward and feed-back system enables a more specific fit and a greater ability for the algorithm to be adjusted overtime or to specific circumstances. This is where of a genetic algorithm is advantageous, in that a genetic algorithm is a form of algorithm that modifies and improves itself over time.

Each best affiliate's “fitness” to be placed into an organisation position is determined by retrieving one or more of the following:
1) determine organisational need in its encoded form;
2) select one or more available candidates as determined by their encoded attributes;
3) match organisational need encodings with available candidate attribute encodings; so that one or more of the available fittest candidates are enabled to be ranked against organisational need;
4) select candidate to be placed against position meeting an organisational need.

Upon iterative evaluations regarding each best affiliate's “fitness” in their placed position in an organisation, if not optimal, then may be replaced so as to form a new generation of the organisation's project operations. The “fitness” criteria are evaluated at the level of:
1. each resource in the form of a candidate, along with
2. the “fitness” of the solution to the need(s) of the organisation.

The fitness criteria takes the form of filtering so the most suitable candidate is selected via review, so if a placed (parent) candidate's fitness (compared to a potential (child) candidate) is less appropriate to an organisational need, then the potential candidate becomes a new (child) candidate is as to evolve the solution to a later generation.

This substitution of a best affiliate candidate, from parent to child based on fitness, evolves the organisational solution to a new generation. This also enables solution modelling for organisational need and resources (candidates) available, along with subsequent organisational evolution programming. Thus solution modelling is enabled through parent-child maps, where a current generation's best affiliate candidate is substituted with a next generation child best affiliate candidate. This ensures that the best affiliate candidate is forwarded under the circumstance of review of organisational need.

In another embodiment, the result of placing a best affiliate candidate forward enables a review, so that not only to enable a child candidate be placed by replacing the parent candidate, but also enable a review of placement so as to provide feedback to enhance the genetic algorithm that performed the initial parent placement.

In an embodiment, an organisational need may have one or more encoded requirements, such that where there are more than one requirements, a specific fitness test, performed by a genetic algorithm's fitness function, ascertains a candidate's encoded attributes against only one or more than one requirement. Where there is one specific requirement that takes priority above other requirements, there may be a review of past placements so as to ascertain whether the selected requirements lead to a desired outcome. This takes the form of a fitness test for selected attributes against specific organisational needs. Selective organisational outcomes are enabled to be directed as desired and/or tested.

The genetic algorithm's multi-filtering process is multi-directional, in that the relevant resources (candidates in the form of experts in their area of expertise) are “filtered” through a plurality of vetting steps performed from a plurality of perspectives (e.g. by the organisation requiring resources, by the group that includes suitably qualified experts among its members, by the individual expert, and by an expert hub).

Each candidate's expertise is encoded and normalised so that expertise:
1. between candidates is enabled to be compared; and
2. is enabled to be applied to fit to organisational unit need;
   therefore, enabling optimisation of suitable candidate selection and allocation to organisational position(s) required.

This candidate allocation is not random, since the selection and allocation is seeded to meet specific parameters as described by an organisation's need, gaps, requirements and/or solution sought. Here, the term seed, seeding and/or seeded is used to insert a candidate into an organisation so as to complete a task as predefined so as to evolve the solution so the organisation's need changes. This subsequent organisational need is expressed as a new functional need, expressed as a fitness function, requiring specific attributes F(x₁) so that the candidate's fitness will be selected by the next generation of candidates.

Traditional resourcing models do not filter resources to this extent and by failing to do so are unable to fine-tune resources to match the need. This multi-filter process incorporating the application of a genetic algorithm is described in further detail later in this document. This is an advantage over traditional resourcing model and improves the efficiency of the market clearing process (i.e. how well an individual resource is matched to a specific organisational need—no matter how narrowly defined that need might be).

The incorporation of a genetic algorithm into the multi-filter process enables automation, selection and allocation of the fittest candidates to an evolving organisational solution at different stages of an organisation's project lifecycle.

This incorporation of a genetic algorithm into the multi-filter process also enables the monitoring of project requirements, which change as the project evolves. Thus, the identification, selection and allocation of new and fitter candidates into the project takes place in the form of new “generations” meeting evolving requirements as the project's changes. This meets that organisation's evolving requirements over specific time intervals or project stages, so as to enable the selection of the “fittest” candidate(s) to the environment as it changes.

The structure of the adhocracy sector 150 (items 150a, 150b) associated with any given organisation is not restricted to any particular sector or layer of the overall organisational structure 100 and where/how an adhocracy sector 150 interacts with the organisation affects the overall organisational structure 100. This is depicted schematically as the difference in organisational structure shape when the adhocracy sector sits at the headquarter sector (adhocracy 150a) compared with when it sits adjacent to the front line sector (adhocracy 150b).

Adhocracies are typically built from a blend of internal and external resources. The advantage of having a method, system and tool for industrialising adhocracy is that they address the difficulty in blending internal and external resources. The preferred embodiments assist the adhocracy sector 150 to enmesh with the remaining organisational structure 100, and for all parts of the structure 100 to fit together.

The flow of operational change and improvement is from adhocracy sector 150a to each of the back office 130, middle office 120 and front line 110 (see arrows marked A), and also to headquarter sector 140. The flow of reporting and information (see arrows marked B) is from front line 110 to middle office 120, middle office 120 to back office 130, back office 130 to headquarter sector 140.

Similar operational/improvement flows and reporting/information flows exist for adhocracy sector 150b, sitting adjacent to the “front line” sector 110. For example, adhocracy 150b could adopt the same the operational/improvement flows and reporting/information flows as would apply for the front line sector 110. This may be appropriate because adhocracy 150b (in the example depicted in FIG. 1) is operating at a similar level within the organisational structure 100 to the front line layer 110. Alternatively, adhocracy 150b could adopt the same reporting and operational flows as adhocracy 150a if this were more appropriate to the specific circumstances. The axis “C” represents the axis about which direction and control pivot.

A traditional organisational structure does not include an adhocracy sector 150. However, this represents a key opportunity for organisations to become agile and respond quickly and efficiently to an opportunity or need. Organisations will increasingly use numerous adhocracies to improve the effectiveness of their organisations and need an industrialised way to achieve this.

For example, when an organisation has a gap within its skillset to implement a new solution, then new resources are sought to fill this gap. The gap is often specified in a project plan which is derived to plan toward producing a particular result or output. Such project plans have implied or explicit phases, where requirements for resources are particularised. An adhocracy enables the management, optimisation and succession of resource delivery within constraints of cost and/or availability to achieve a particular outcome.

Conversely, the specification of resources required to provide a solution may be left to the adhocracy. Thus, a sifting of the project's needs relative to the resources required is used to create a schedule stipulating human requirements in their indivisible form, so that the output will be optimised according to project need and availability.

The adhocracy takes the organisation need(s), project plan and/or resource requirements and implements resource allocation rules which govern what, how and when the indivisible resources are allocated.

In an embodiment (see FIG. 2), the method for industrialising adhocracy 200 includes the step of sourcing relevant expertise to address an earlier identified organisational need through a multi-filtering process (step 220), wherein the multi-filtering process incorporates the application of a genetic algorithm to facilitate the blending of an organisation's internal and external resources by applying a plurality of filters, in the form of encoded criteria, which are normalised within and across all candidates, to select each required candidate as a resource to efficiently match an organisational need (preferably narrowly defined) with relevant expertise. The method differs from traditional resourcing business models, which lack the granularity to match a narrowly defined need. A narrowly defined need is better met by a specific resource.

The genetic algorithm has the advantage of using a stochastic optimisation since the allocation of the candidate's performance in the selected environment is initially unknown. Therefore, simulations can be used to model and therefore optimise the most suitable candidate(s) for the environment, using the criteria that an organisation has specified for a specific environment. The most suitable candidate will be the fittest candidate for the purpose in the specific environment. Here, the genetic algorithm provides a search technique to isolate the selection of possible optimal solutions.

In one embodiment, the multi-filtering process, incorporating the application of a genetic algorithm, provides the solution through selecting a resource, in the form of a candidate as the most suitable expert, to fulfill an organisational problem, solution required and/or gap in existing skills.

The selection of the most suitable or “fittest” candidate (i.e. fitness for purpose) is enabled by a genetic algorithm to select all possible candidates (n) as a random selection followed by selecting a subset of possible candidates though reading the candidate's encoded criteria (which is normalised within and across all candidates). The individual candidate's “fitness” as encoded is nominated with a value (x).

The selection criteria of fitness are contained within the genetic algorithm as a fitness function, so the “fittest” candidate can be selected. Therefore, the selection of most suitable candidate(s) is based on the organisational need as a function (F) and the candidate's fitness (x). This candidate selection is described as the most appropriate solution to f(x) for each candidate in the population.

The candidate's encoded information, along with the organisation need, provides the parameters to control the flow of the genetic algorithm. These parameters include the number of positions available, skills required with each position, cost constraints (so, for example, to provide limits on the number of generations) along with other constraints as required.

The selections of the “fittest” candidates are extracted as possible solutions based on their “fit” which is a function of each candidate's encoded information. According to the selection criteria utilised, one or more candidates can be selected based on their fitness values using the selection criteria nominated.

Once a candidate is selected and placed into an organisation according to the organisation's need, then a review of need is conducted. A second parse of the genetic algorithm is then conducted to determine if a more suitable candidate is available for the organisations to sort and select the most suitable candidates using a “fitness” function according to the organisation's need(s). Since the organisation's needs may have changed since the first candidate was selected, so the function (F) criteria may require amendment. This is a second parse of the genetic algorithm as a multi-filter process, which evaluates all potential candidates for the organisation's conditions, which may have changed.

If a new candidate is selected as having a better fitness to meet the organisation's functional requirements, then this new or “child” candidate is allocated to the position of the previous candidate (the parent candidate) so a new generation of solution is applied to organisation need.

The genetic algorithm's multi-filter process is performed in an iterative fashion. This enables the solution's evolution through the selection of fitter candidates, as applied to the organisation's need, as the environment in which they are placed is altering within each generation, leading to succession with the placement of the next or child candidate. Therefore, the selection of one or more candidate(s) is appropriate to an organisation's changing need, so that the multi-filter process incorporates the application of a genetic algorithm, which enables the efficient matching of organisational need to relevant expertise of one or more candidates.

In an embodiment, the method for industrialising adhocracy 200 includes a further step of performing a holistic review of an organisation's operations to identify, capture or respond to one or more organisational needs (step 210). This step 210 may be performed internally by the organisation or externally. In either case, the holistic review is performed in iterative fashion along with the step 220 of sourcing expertise. The iterative nature of the sourcing and review process improves the blending of internal and external resources, with the organisation's satisfaction (and ongoing needs) reviewed each cycle.

In an embodiment, the holistic review includes a review of the calculated impact on an organisation (e.g. the change in organisational structure) by adding (or removing) an adhocracy (i.e. one or more service providers or experts acquired to meet an organisational need). The impact is calculated by processing organisational data and may be included in a report and/or as a visual representation of the impact on the organisational structure (e.g. organogram) and operations. This may isolate new or changed organisational need. The fitness function F(x) is enabled to be adapted to specify additional or changed requirements. The review of need relative to candidate(s), who were placed with fitness (x), is parsed across candidates available (which is a new generation of possible candidates), so as to select any candidate that may have a better “fitness” to the organisation's current need.

A visual representation of such expressions is enabled to be accessed (viewed) by a user (e.g. an organisation looking to add resources to meet an identified need) which, in some arrangements, can also provide modeling of solutions available through the placement of a selected number of candidate placements according to organisation need as it's environment changes. This organisational need, viewed holistically as environmental change also accounts for the impact that a candidate, once placed, has on an organisation so as to incorporate the evolution of a solution. Therefore, one or more generations of candidate placements are applied to the organisation's changing need, so the solution(s) are enabled to evolve. Additional criteria are enabled to also be included such as cost and efficiency improvements through one or more generations of candidates.

Thus the method for industrialising adhocracy 200 can be performed in an iterative manner (depicted by the dashed line in FIG. 2), with the processes of reviewing the organisation and sourcing expertise through a filtering process being repeated for each resource required—when required.

In an embodiment, the step 210 of performing a holistic review of an organisation's operations includes the computer-enabled substep of performing a componentisation method (see FIG. 4). The componentisation method 400 is performed by using a componentisation tool (see item labelled 300 in FIG. 3). Referring to FIG. 3, the componentisation tool 300 is a computer program product comprising programming instructions for a componentisation method. The componentisation tool 300 is a software tool embodied in a computer readable storage medium 310 (e.g. computer, server, cloud, internet, or other storage device).

The componentisation method facilitates the identification of one or more work components required by an organisation. Each work component (or other resource component) is a discrete unit of work in indivisible form. In this way, the algorithm-driven method provides granularity in componentising an organisation's existing resources and existing needs (gap in resources).

In one embodiment, each candidate has their skills, as an indicator of their fitness, encoded so as to template this information so it is comparable across candidates. This may take the form of a fitness function comparing fitness of each affiliate in the form of string indicating that affiliate's fitness individually and/or ranked against other affiliates, to meet a specified organisational need.

Each such candidate, as a work component, can then be appropriately matched to the appropriate position as required by an organisation. The granularity in the matching process comes from breaking down each component of work into as indivisible a form as possible—the smallest possible discrete unit (component) of work.

For example, an organisation has a desired objective identified which needs to be meet through acquiring the appropriate resources at specified times. These resource needs require one or more specific allocations to one or more project sectors in a linear, parallel or matrix manner.

The resource allocation(s) requirements must be balanced against resources available within a specified cost and/or time parameters. Therefore, once one or more identified needs are determined in their indivisible form, the selection of the most suitable resources in their indivisible form must be selected so a synergistic advantage achieved. Once a series of indivisible resources have been identified as candidates to fulfill a resource gap, then there is the need for the selection and subsequent allocation of the indivisible resources to optimise an outcome. That is, from the many suitable candidates that can fill one or more resource gaps, a genetic algorithm is applied to select a candidate as the best affiliate forward, so as to evolve towards a better solution.

Organisational data captured using the system is processed using an algorithm to “calculate” the impact of adding one or more service providers (constituting one or more adhocracies) to an organisation's operations and ultimately to the organisational structure. As described above, the organisation's requirements are f(x), where the candidate is selected as the most appropriate solution to this function. The calculated impact can be accessed by inclusion in a report, or through a visual representation viewable by a user, e.g. through a computer display, tablet, smartphone or any other display connected to a processing means.

The programming instructions of the componentisation tool 300 are performed by a processing means (e.g. a processor 320 of the computer system 330). The componentisation tool 300 may communicate with a server 340 or a computer network including the internet or the cloud 350, or a mobile communications network.

Referring to FIG. 4, in a further embodiment, the componentisation method 400 performed by the componentisation tool includes the steps of:
(a) capturing organisational data regarding:
   i. an organisation's existing operations;
   ii. one or more work components required to meet an organisational need identified by an operational review; and
   iii. one or more resources required to deliver said one or more work components (refer step 410);
(b) processing of organisational data by adding the resource(s) required to the organisational operations (step 420);
(c) analysing captured organisational data and the processed information from step 420 to calculate an impact on the organisation's structure (step 430);
(d) rendering a visual representation of the calculated impact (step 440), in which the visual representation is printable, downloadable or otherwise accessible to a user of the componentisation tool. In an embodiment, the visual representation may be made further accessible as part of a generated report, wherein the report is also printable, downloadable or otherwise accessible by a user of the componentisation tool (step 450).

Steps 410, 420 and 430 may be performed in an iterative fashion (indicated by the dashed arrow), with repeated cycle(s) as new input is entered new needs arise or simply to review organisational performance. With each cycle, the organisational organigram changes structure or shape—as depicted schematically by items 430a, 430b and 430c. Item 430a contains an exemplary organisation's starting organisational structure, depicted in solid lines. At the end of a first cycle, the organisational structure has transmogrified—the change to the organisational structure is depicted schematically by a new layer of operations or resources, shown in dotted lines. The new layer (dashed lines in item 430a) sits adjacent the original structure (solid lines in item 430a), the combined layers now forming the organisational structure.

The cycle of steps 410, 420 and 430 is repeated, resulting in further transformation of the organisational structure—this time depicted in item 430b. In this example, the organisational structure at the start of the second cycle is as depicted in item 430a. However, other options exist. For example, if a short-term purpose is met and completed, the organisational structure might revert to the original starting point (i.e. only the solid lines in item 430a).

Assuming that the starting point is the organisational structure shown in item 430a, a cycle of steps 410 to 430 results in additional resources (dotted lines) being added to the organisation (e.g. two adhocracies are built in one cycle, changing the organisational structure from item 430a to item 430b) or being removed from the organisation (e.g. an adhocracy is disbanded in different cycle, changing the organisational structure from item 430b to item 430c) so that the final organisational structure at any point in time represents the combination of solid and dotted lines.

The cycle can repeat as many times as required or desired, and the organisational structure can be added to, removed from and otherwise transmogrified to meet the needs of the situation. This is depicted schematically by the oversized ellipsis ( . . . ) in FIG. 4.

For example, an organisation with resource needs has a population of resource solutions in their indivisible form. A resource solution take the form of a candidate with a particular set of skills which, when applied to the genetic algorithm, takes the form of resource solution encodings.

The iteration of each candidate's encodings, as captured in a templated format, so that the selection and addition of individual resources (e.g. experts) to the organisation through a multi-filtering process using a generic algorithm, where a multi-dimensional filtering exists in the form of review of organisational performance and satisfaction with each added resource (service provider) with each iteration. Each iteration is one generation of the solution's evolution, so the fitness of each candidate is evaluated with the optimisation of the solution to a specific organisational problem. The selection of the best affiliate forward in one generation may not be appropriate within a later generation, since the solution has evolved and so the organisation need may requires a further or different resource allocation more suitable to the changed environment. Consequently, when a new resource is allocated, then a new generation of solution is evolved. The genetic algorithm parses each generation until an optimal solution has being achieved (a satisfactory fitness level) and/or the resources/costs available have being exhausted.

This solution evolution to provide the “fittest” solution to a specific environment involves programming instructions including the genetic algorithm which, in an additional embodiment, includes the following steps in addition to or separate earlier embodiments:
1. Capture organisational need as a function (F) of required fitness (x);
2. Parse n candidates available against F(x);
3. If one or more candidates satisfy the conditions expressed in F(x) then select the “fittest” or most appropriate solution to F(x) as a candidate;
4. Nominate remaining candidates as NOT satisfy the conditions expressed in the fitness function F(x);
5. Check if other organisational need needs to be satisfied as expressed in the fitness function F(x);
6. Review expressed in the fitness function F(x) to determine if required fitness (x) has changed, if
7. Yes, then return to Step 1;
8. No, then stop

The above process steps consist of, in part, an algorithm which is described in a sequential order; however, such processes may be configured to work in different orders, so that the order of steps does not necessarily indicate a requirement that the steps be performed in that order. In further embodiments, determinations of the resources required to be selected to meet one or more discrete units of work in indivisible forms, and in still further embodiments, also defining a resource(s) required, are made using artificial intelligence including genetic algorithms. Such artificial intelligence in alternate embodiments may include neural net, Bayesian algorithm, pattern recognition, expert systems, case based reasoning, fuzzy systems, hybrid intelligent systems, evolutionary computation, concept processing or any combination thereof.

In an embodiment, the report includes a visual representation of the calculated impact on an organisational structure—for example, a transmogrification of the organigram (organisational structure) as a result of the resources identified as required to meet the organisational needs. An example of a visual representation of the impact on an organisational structure is a visual representation of the organisational structure (organigram). An exemplary report may depict how the organisational structure transmogrifies with each generational cycle such as the changes depicted in FIG. 4 (items 430a to 430c).

The advantage of performing an holistic review of an organisation's operations (step 210 of FIG. 2) is that it provides an early “filter” to the process of obtaining the required resources to fulfill an organisation's needs. This is because a user using the componentisation tool is taken through a rigorous and well defined process for reviewing an organisation and its operations as part of the process of identifying an organisation's needs. Most organisations skip this step or require management consultancy expertise to perform this step before advertising for particular skills or job descriptions. However, without first undertaking this holistic review, the skills or resources sought through an adhocracy may not fit well with organisational structure or operations.

Referring to FIG. 2, the next step in the preferred embodiment of a method of industrialising adhocracy is the step 220 of sourcing relevant expertise to address an identified organisational need through a multi-filtering process using a genetic algorithm, wherein the multi-filter process overcomes the difficulties of traditional resourcing business models.

For example, an organisation's problem may be solved in a variety of ways or routes leading towards a desired result. Therefore, a series of suitable candidates may be selected through a method of “seeding” to lead towards the specified outcome. This “seeding” will harvest a number a suitable candidates from the population of potential candidates available, for example, selecting the top three (3) candidates. The selection of the most suitable candidate, as the best affiliate forward, is ultimately chosen by the adhocracy and/or the organisation involved.

Subsequent best affiliates forward are selected to produce a new generation of solution via the multi directional filtering criteria, so as to provide a “fitter” solution to the evolved problem. The best affiliate forward selection takes place using a fitness function, which looks at the templated attributes of each candidate and selects the most suitable candidate on a calculated merit basis towards meeting the requirements for the required resource within the plan at the stage required.

FIG. 5 is a flowchart of the multi-filtering process for matching a resource requirement to a service provider according to an embodiment of a system for industrialising adhocracy.

In an embodiment, the system of industrialising adhocracy includes:
(a) a method of industrialising adhocracy including the step of sourcing relevant expertise to address an identified organisational need through a multi-filtering process; and
(b) access to one or more associations of service providers, said associations being categorised according to an area of expertise.

By way of example only, an association of service provider includes a professional association and/or industry body. In this way, the system of industrialising adhocracy could be used to select one or more resources in the form of one or more professional service providers belonging to a professional association.

The method of industrialising adhocracy further includes a step of performing a holistic review of an organisation's operations to identify an organisational need. In an embodiment, the holistic review is performed using a componentisation tool. This is applies a filter to the process of sourcing appropriate resources, by assessing an organisational need for services in an holistic manner, yet achieving granularity through the componentisation of existing operations (and resources) to identify gaps and resources required to meet the organisation's needs.

The multi-filtering process of the system includes the following sub-steps:
(a) the system encourages and invites one or more service providers to qualify for association membership (step 510)—qualifying for association membership is discussed further below;
(b) the system invites one or more bids for a work component from one or more qualified organisation or association members (step 520). Bidding indicates availability, because only association members who are available submit a bid. The process of bidding is made efficient by seeking bids only from qualified association members—this filters out bids from service providers who do not possess the appropriate qualifications, expertise or experience. In an embodiment, the system selects (filters) suitable categories of service providers by identifying which associations have qualified members with appropriate skills to meet an identified organisational need. This step of selecting appropriate associations is performed before inviting bids, so that bids are only invited from qualified association members of selected associations;
(c) an expert hub compiling a short-list of bids received for a work component (step 530), wherein the expert hub comprises one or more experts in a relevant field of expertise.

The dashed line in FIG. 5 illustrates how the multi-filtering process can be performed repeatedly for each specification of an individual resource required for an individual adhocracy. The repetition can occur in parallel (e.g. when sourcing multiple resources at the same time) or in series (e.g. when addressing the needs of a different part of a project in time or place). For example, if the adhocracy requires 10 resources, five of which are internal (or met), then the multi-filtering process may be run a further five times to source the remaining five resources needed. With each resource acquired, the overall impact on the organisation is reviewed (e.g. by looking at the change in organisational structure or the change in “shape” of the adhocracy sector referred to in FIG. 1 (item 150)).

The final step (not depicted) is that after filtering of suitable resources by the system (including assessment on the impact of the organisation), a client is presented with a filtered selection of qualified, available resources who have been assessed by an expert hub as having the relevant skills and expertise to meet the organisational needs identified at the beginning of the process.

This step has utilised the genetic algorithm to maximise the outcome according to possible constraints such as time, cost and/or resources available, so as to provide the “fittest” resources available for the problem's environment. The best affiliate forward selections may be substituted so as a new generation of solution is evolved. Parallel implementations along with arrays of implementations of best affiliate forward are enabled, so intergenerational solutions may contain a large percentage of the same best affiliates forward, since the substitution of only one best affiliate forward out of many can lead to a new generation's solution.

In an embodiment, the system for industrialising adhocracy includes access to different associations for different industries—this is depicted schematically in FIG. 5 by separate “tabs” (labelled “Industry 1”, “Industry 2” and “Industry X”). Each association has its own qualifications for membership (e.g. an association for construction, an association for film production, an association for professional services). An existing association may be selected or the “association” can be subdivided as required so that highly specialised resources can be identified and generated to meet an organisation's needs. Alternatively, a new association can be generated to meet an organisational need.

The multi-filtering process has an advantage over traditional resourcing models by combining several layers of “filters” to increase the overall efficiency and reliability of the process of sourcing relevant expertise. The process can be performed in an iterative manner for each specification of an individual.

Unlike current resourcing models, all service providers (specialists, experts) must first qualify for association membership. The association may vary according to the area of expertise, as may membership requirements. For example, all professionals may need to be registered with the relevant professional body plus, for example, legal profession experts may need to have a stipulated number of years of post-qualification experience as well as, say, a post graduate qualification in their area of specialty. Only this pool of experts who are “qualified” for membership will have an opportunity to “bid” for providing the required work component. In an embodiment, the method of industrialising adhocracy includes a step of inviting one or more bids for provision of a work component from qualified association members.

As such, qualifying for association membership involves a service provider meeting one or more “sets” of rules or flags such as:
(a) whether the service provider (expert) possesses a qualification in an appropriate area of expertise (e.g. law, finance, marketing)
(b) whether the service provider has appropriate specialisation or further qualification (e.g. specialisation in intellectual property)
(c) whether the service provider has the appropriate experience (e.g. within a particular sector—banking, construction, etc.)
(d) whether the service provider has achieved a specified “merit” status (e.g. reputational status through client feedback, industry standing, outcomes achieved, contracts completed or so on).

By way of example only, the system for industrialising adhocracy may include access to any number of associations categorised by:
(a) area of expertise—this would be a categorisation of associations by a broad area of expertise (e.g. law, banking, marketing);
(b) qualifications—using “law” as an example, all association members would require a law degree;
(c) specialisation—a service provider may possess specialisation or further qualifications within the relevant area of expertise, such as a valid practising certificate in New York, Australia or the United Kingdom. Alternatively, an association might require specialisation in, say, corporate law, commercial law or litigation. Specialisation can be narrowly defined so that association membership is qualified only for specialist service providers;
(d) experience—an association may require (through specifying rules for membership that must be meet before membership will be “qualified”). For example, this may be a specified number of years of post-admission legal practice, or experience in providing legal services to a specified sector (e.g. competition law to the banking sector in Australia);
(e) merit—an association may require certain merit status for qualification (e.g. a litigator who has won more than a specified percentage of cases)

The associations may be pre-existing or generated in response to an identified organisational need. Generation or creation of an association may be de novo or achieved by subdividing an existing association such that the newly generated association represents a highly specialised group of service providers.

The bidding process ensures availability of the relevant expert (unlike traditional recruiting models, which often involve contacting names on a database that may no longer be available or suitably qualified—for example, no longer practising).

Finally, all bids received from such “qualified” experts are reviewed by an expert hub comprising one or more experts in the relevant field. The bid submitted provides an opportunity for vetting of suitable service providers by experts who may appreciate from the bid submitted that, although qualified and available, the bidder's experience and expertise or merit status is not relevant or appropriate for the work component required.

The multi-filtering process involves further steps than are usually performed by any other current resourcing business model. However, the additional filters assist to improve overall efficiency and effectiveness of the resources secured by reducing time wasted in reviewing inappropriate applicants or indeed failing to understand the organisation's needs before advertising.

In an embodiment, there is also provided a system for facilitating industrialised adhocracy including:
(a) a method of industrialising adhocracy, the method including the step of sourcing relevant expertise to address an identified organisational need through a multi-filtering process;
(b) access to one or more associations of service providers, said associations being categorised according to an area of expertise,
   association membership requirements being tailored by industry, professional associations, recognised specialties and so on;
(c) a componentisation tool;
(d) a componentisation method performed by the componentisation tool.

In an embodiment, the method of industrialising adhocracy includes the further step performing of a holistic review of an organisation's operations to identify an organisational need.

An advantage of the preferred embodiments is that they empower an organisation to apply a management consultancy filter to the process of identifying need, and then to build an adhocracy to quickly and efficiently meet that need. This allows organisations to be agile, flexible and responsive to needs.

A further advantage is that the preferred embodiments deliver an efficient matching process with granularity provided through the componentisation of needs—a work component or other resource component required by an organisation. This is achieved by forcing users to define a need in an indivisible form (i.e. the smallest possible unit of a work component or other resource component that can be described). This enables precise matching of an organisational need to a resource required to meet that need. The preferred embodiments also deliver matched resources (e.g. professional expertise) to the componentisation of need identified.

The invention provides a method, system and tool for industrialising adhocracy for use in strategy implementation and change management. However, it will be appreciated that the invention is not restricted to these particular fields of use and that it is not limited to particular embodiments or applications described herein.

Comprises/comprising when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A componentisation tool for performing a method of industrialising adhocracy,
wherein the method includes a componentisation process,
wherein the componentisation process is performed by programming instructions embodied in a computer readable storage medium and comprises the steps of:
(a) capturing organisational data, wherein the organisational data includes data regarding one or more of the following:
i. an organisation's existing operations;
ii. an organisation's existing resources;
iii. an organisation's need;
(b) processing said organisational data to assess whether one or more of the following are sufficient to meet an organisation's need:
i. an organisation's existing operations;
ii. an organisation's existing resources;
(c) calculating a difference between:
i. existing operations and existing resources; and
ii. an organisational need,
to identify one or more work components required to address the organisational need;
(d) defining a resource required to meet each said identified one or more work components required by an organisation,
(e) selecting one or more resources from a pool of relevant expertise using a fitness function to meet the resource so defined,
wherein each said one or more work components is a discrete unit of work in indivisible form such that granularity is provided in defining a resource required to provide each said identified one or more work components required by an organisation or a part thereof.

2. The componentisation tool of claim 1, wherein the componentisation process includes one or more of the further steps of:
(a) processing said organisational data to match an organisational need with one or more work components using a fitness function to calculate the resources required to meet one or more work components required by an organisation;
(b) rendering a report including one or more of a textual document, a visual representation of said impact, wherein said report is printable, downloadable or accessible by viewing on a display.

3. The componentisation tool of claim 2, wherein said fitness function is determined using an algorithm.

4. The componentisation tool of claim 1, wherein the componentisation process includes processing said organisational data to match an organisational need with one or more work components using a fitness function in the form of algorithm to calculate an impact on said organisation's structure by adding one or more affiliates in the form of service providers to said organisation's operations.

5. The componentisation tool of claim 1, including a further step of performing a review of an organisation's operations to obtain the organisational data, said organisational data facilitating identification of an organisational need.

6. The componentisation tool of claim 5 wherein the review of an organisation's operations includes one or more of the following steps:
(a) identifying an organisation's existing operations;
(b) identifying one or more additional operations required to deliver an identified outcome;
(c) assessing any differences between existing operations and additional operations required;
(d) assessing existing resources to identify one or more organisational needs,
(e) wherein said review is performed at one or more of the following times:
i. before the step of performing a componentisation process;
ii. after the step of performing a componentisation process.

7. The componentisation tool of claim 5 wherein the review of an organisation's operations includes componentising an organisation's existing resources into one or more work components, each said resource component being a discrete unit of a resource in indivisible form.

8. The componentisation tool of claim 5, including a further step of performing a holistic review of an organisation to identify an organisational need, wherein the holistic review includes a substep of componentising an organisation's existing operations to identify a work component required.

9. The componentisation tool of claim 8 including a further step of sourcing a relevant resource to address an identified organisational need through a multi-filtering process, wherein the multi-filtering process includes the following sub-steps:
(a) qualifying one or more service providers for association membership, each said service provider thereafter constituting a qualified association member;
(b) receiving one or more bids for provision of a work component from one or more qualified association members, each said qualified association member being available to provide said work component;
(c) reviewing said one or more bids by an expert hub, wherein the expert hub comprises one or more experts in a relevant field of expertise.

10. The componentisation tool of claim 9, wherein the sub-step of qualifying a service provider for association membership includes:
(a) applying a flag to information regarding a service provider,
wherein applying the flag determines whether or not a service provider possesses specified minimum criteria regarding one or more of:
i. an area of expertise;
ii. qualifications;
iii. specialisation;
iv. experience;
v. merit,
(b) excluding one or more service providers who do not possess said specified minimum criteria from bidding for a specified work component,
such that only said one or more service providers who possess said specified minimum criteria are qualified for association membership.

11. The componentisation tool of claim 10 wherein the method of industrialising adhocracy includes one of the following further sub-steps:
(a) generating one or more associations according to said specified minimum criteria of association members such that a number of potentially suitably qualified individual service providers are included in any such generated association;
(b) selecting one or more associations,
wherein an association is selected according to whether its qualified members provide services in an area of expertise relevant to said identified organisational need,
such that one or more appropriate associations is selected before inviting one or more bids for a work component from qualified association members.

12. The componentisation tool according to claim 11 including an additional step comprising the step of inviting one or more bids for provision of a work component from qualified association members.

13. The componentisation tool of claim 11 wherein the step of generating one or more associations appropriate to said identified organisational need includes a substep of subdividing a pre-existing association such that a generated association represents a highly specialised group of service providers.

14. The componentisation tool of claim 9, wherein the expert hub performs a further step of compiling a short-list of said one or more bids received from one or more qualified association members, wherein said expert hub excludes from said short-list any bid received from a qualified association member otherwise considered inappropriate to provide said work component.

15. The componentisation tool of claim 9, wherein the review of an organisation's operations includes a review of an organisation's satisfaction with each service provider selected through the multi-filtering process to provide a work component.

16. The componentisation tool of claim 9, wherein one or more of the following steps are performed in an iterative manner:
(a) the multi-filtering process;
(b) the review of an organisation's operations to obtain organisational data;
(c) the holistic review of an organisation to identify an organisational need.

17. A computer-enabled method of industrialising adhocracy including a componentisation process, wherein the componentisation process is performed by programming instructions embodied in a computer readable storage medium, wherein the componentisation process comprises the steps of:
(a) capturing organisational data, wherein the organisational data includes data regarding one or more of the following:
i. an organisation's existing operations;
ii. an organisation's existing resources;
iii. an organisation's need;
(b) processing said organisational data to assess whether one or more of the following are sufficient to meet an organisation's need:
i. an organisation's existing operations;
ii. an organisation's existing resources;
(c) calculating a difference between:
i. existing operations and existing resources; and
ii. an organisational need,
to identify one or more work components required to address the organisational need;
(d) defining a resource required to meet each said identified one or more work components required by an organisation,
(e) selecting one or more resources from a pool of relevant expertise using a fitness function to meet the resource so defined,
wherein each said one or more work components is a discrete unit of work in indivisible form such that granularity is provided in defining a resource required to provide each said identified one or more work components required by an organisation or a part thereof.

18. The computer-enabled method of industrialising adhocracy of claim 17, wherein the componentisation process includes one or more of the further steps of:
(a) processing said organisational data to match an organisational need with one or more work components using a fitness function to calculate an impact on said organisation's structure by adding said one or more service providers to said organisation's operations;
(b) rendering a report including one or more of a textual document, a visual representation of said impact, wherein said report is printable, downloadable or accessible by viewing on a display.

19. The computer-enabled method of industrialising adhocracy of claim 18, wherein said fitness function is determined using an algorithm.

20. The computer-enabled method of industrialising adhocracy of claim 17, wherein the componentisation process includes processing said organisational data to match an organisational need with one or more work components using a fitness function in the form of an algorithm to calculate an impact on said organisation's structure by adding one or more affiliates in the form of service providers to said organisation's operations.

21. The computer-enabled method of industrialising adhocracy of claim 17, including a further step of performing a review of an organisation's operations to obtain the organisational data, said organisational data facilitating identification of an organisational need.

22. The computer-enabled method of industrialising adhocracy of claim 21 wherein the review of an organisation's operations includes one or more of the following steps:
(f) identifying an organisations existing operations;
(g) identifying one or more additional operations required to deliver an identified outcome;
(h) assessing any differences between existing operations and additional operations required;
(i) assessing existing resources to identify one or more organisational needs,
wherein said review is performed at one or more of the following times:
i. before the step of performing a componentisation process;
ii. after the step of performing a componentisation process.

23. The computer-enabled method of industrialising adhocracy of claim 21 wherein the review of an organisation's operations includes componentising an organisation's existing resources into one or more work components, each said resource component being a discrete unit of a resource in indivisible form.

24. The method of industrialising adhocracy of claim 21, including a further step of performing an holistic review of an organisation to identify an organisational need, wherein the holistic review includes a substep of componentising an organisation's existing operations to identify a work component required.

25. The computer-enabled method of industrialising adhocracy of claim 24 including the further step of sourcing a relevant resource to address an identified organisational need through a multi-filtering process, wherein the multi-filtering process includes the following sub-steps:
(a) qualifying one or more service providers for association membership, each said service provider thereafter constituting a qualified association member;
(b) receiving one or more bids for provision of a work component from one or more qualified association members, each said qualified association member being available to provide said work component;
(c) reviewing said one or more bids by an expert hub, wherein the expert hub comprises one or more experts in a relevant field of expertise.

26. The computer-enabled method of industrialising adhocracy of claim 25, wherein the sub-step of qualifying a service provider for association membership includes:
(a) applying a flag to information regarding a service provider,
wherein applying the flag determines whether or not a service provider possesses specified minimum criteria regarding one or more of:
i. an area of expertise;
ii. qualifications;
iii. specialisation;
iv. experience;
v. merit,
(b) excluding one or more service providers who do not possess said specified minimum criteria from bidding for a specified work component,
such that only said one or more service providers who possess said specified minimum criteria are qualified for association membership.

27. The method of industrialising adhocracy of claim 26 wherein the method includes one of the following further sub-steps:
(a) generating one or more associations according to said specified minimum criteria of association members such that a number of potentially suitably qualified individual service providers are included in any such generated association;
(b) selecting one or more associations,
wherein an association is selected according to whether its qualified members provide services in an area of expertise relevant to said identified organisational need such that one or more appropriate associations is selected before inviting one or more bids for a work component from qualified association members.

28. The method of industrialising adhocracy of claim 25 including an additional step comprising the step of inviting one or more bids for provision of a work component from qualified association members.

29. The method of industrialising adhocracy of claim 27 wherein the step of generating one or more associations appropriate to said identified organisational need includes a substep of subdividing a pre-existing association such that a generated association represents a highly specialised group of service providers.

30. The method of industrialising adhocracy of claim 25, wherein the expert hub performs a further step of compiling a short-list of said one or more bids received from one or more qualified association members, wherein said expert hub excludes from said short-list any bid received from a qualified association member otherwise considered inappropriate to provide said work component.

31. The method of industrialising adhocracy of claim 21, wherein the review of an organisation's operations includes a review of an organisation's satisfaction with each service provider selected through the multi-filtering process to provide a work component.

32. The method of industrialising adhocracy of claim 25, wherein one or more of the following steps are performed in an iterative manner:
(a) the multi-filtering process;
(b) the review of an organisation's operations to obtain organisational data;
(c) the holistic review of an organisation to identify an organisational need.

33. A componentisation tool of claim 3, wherein said algorithm is in the form of a genetic algorithm.

34. The computer-enabled method of industrialising adhocracy of claim 19, wherein said algorithm is in the form of a genetic algorithm.

35. (canceled)
